(19) United States
(12) Patent Application Publication
(10) Pub. No.: US 2008/0036419 A1
(43) Pub. Date: Feb. 14, 2008

(54) BATTERY ISOLATOR

(75) Inventors: ALEXANDER COOK, DUBLIN, OH (US); ALEXANDER ISURIN, DUBLIN, OH (US)

Correspondence Address: ELEY LAW FIRM CO., 7870 OLENTANGY RIVER RD, SUITE 311, COLUMBUS, OH, 43235, US

(73) Assignee: VANNER, INC., HILLIARD, OH (US)

(21) Appl. No.: 11/873,536

(22) Filed: Oct. 17, 2007

Related U.S. Application Data
(63) Continuation-in-part of application No. 11/035,608, filed on Jan. 14, 2005, now abandoned.
(60) Provisional application No. 60/536,328, filed on Jan. 14, 2004.

(51) Int. Cl. H02J 7/00

(52) U.S. Cl. 320/104; 320/103

(57) ABSTRACT

A battery isolator for an electrical system having a first battery, a second battery and a charging source continuously coupled to one of the first and second batteries. The battery isolator comprises an inductor having a first terminal and a second terminal, a first switch connected between a positive terminal of the first battery and the first terminal of the inductor, and a second switch connected between a second terminal of the inductor and a positive terminal of the second battery. The first and second switches are selectively actuated in a predetermined manner, such that the battery isolator can be used to charge one of the first battery and the second battery. At least one of the first and second switches may be selectively actuated to prevent one of the first and second batteries from substantially discharging the other battery when a charging source is not present.

This application is a continuation-in-part of U.S. patent application Ser. No. 11/035,608, filed Jan. 14, 2005, which claims priority to U.S. provisional application 60/536,328, filed Jan. 14, 2004, the contents of each being hereby incorporated by reference thereto.

### FIELD

This invention relates to a system for electrically isolating a plurality of batteries in a vehicle electrical system to control charge and discharge of each battery. In particular, the present invention controls preferential charging of batteries and impedes discharged batteries from draining energy from charged batteries.

### BACKGROUND

More than one battery may be installed in some vehicles, such as recreational vehicles and trucks, the batteries being connected to a common charging source such as an alternator. A first battery is typically reserved for starting the engine of the vehicle, while the second is for bulk energy storage, e.g., static power used to operate accessories when the primary energy source is not available, such as when the vehicle engine (the prime mover) is off. In such electrical systems the highest priority is to charge the engine-starting battery or batteries, since the engine is necessary to operate the vehicle. In multiple-battery systems, if a fully charged battery is connected directly to a discharged battery, the voltage in the charged battery will cause current to flow from the charged battery into the discharged battery until the current drawn from both batteries reaches equilibrium. As a result, the engine-starting battery can become discharged and unable to start the engine, leaving the vehicle disabled. Others have attempted to prevent this condition by electrically isolating the starting battery from the bulk storage battery. In addition, the batteries may be of different types, such as a flooded lead acid battery for the cranking battery and an AGM battery for the bulk storage battery. These batteries have differing charge requirements, making it beneficial to be able to independently control the charge voltage for each battery. There are two primary types of battery isolators, known in the art as diode isolators and contactor isolators.

Diode isolators have significant drawbacks. A first drawback is loss of efficiency due to heat generated by the diodes as a result of the charging current flowing through them. The heat losses reduce the efficiency of the electrical system and drives a need for cooling the diodes. A second drawback is a reduced charge voltage, on the order of about a 0.5 to 1.0 volt reduction, due to the inherent voltage drop of a semiconductor diode. In addition, when both the starting and bulk storage batteries are in a condition wherein both batteries are close to the same voltage, the bulk storage battery will typically draw most of the charge current if it is depleted, because of its large capacity and correspondingly higher charging current requirement in comparison to the starting battery.

Contactor isolators suffer from drawbacks as well, the first of which is a limited service life. When contactor isolators are connected between a full battery and a discharged battery, large currents can flow, stressing electrical contacts of the isolator and causing wearing of the contacts. In addition, the contactor may be closed or opened due to battery charge sensing errors inherent in the charging system, and multiple attempts may be necessary before the system voltages reach levels where the contactor can remain closed. This causes loss of charge time and further wear on the contactor. Thus, there is a need for a battery isolator that overcomes the limitations of diode isolators and contactor isolators.

### SUMMARY

The present invention is a battery isolator for an electrical system that includes at least a first battery and a second battery, wherein a negative terminal of each of the first and second batteries are connected together at a ground point and a charging source is continuously connected in parallel with one of the first and second batteries. The battery isolator comprises an inductor having a first terminal and a second terminal. A first switch is connected between a positive terminal of the first battery and the first terminal of the inductor, and a second switch is connected between a second terminal of the inductor and a positive terminal of the second battery. The first and second switches are selectively actuated to charge at least one of the first battery and the second battery.

Another aspect of the present invention is a battery isolator for an electrical system that includes at least a first battery and a second battery wherein a negative terminal of each of the first and second batteries are connected together at a ground point and a charging source is continuously connected in parallel with one of the first and second batteries. The battery isolator comprises an inductor having a first terminal and a second terminal. A first switch is connected between a positive terminal of the first battery and the first terminal of the inductor. A second switch is connected between a second terminal of the inductor and a positive terminal of the second battery. A third switch is connected between the first terminal of the inductor and the ground. A fourth switch is connected between the second terminal of the inductor of the ground. The first, second, third and fourth switches are selectively actuated to charge at least one of the first battery and the second battery.

Yet another aspect of the present invention is a battery isolator for an electrical system that includes at least a first battery and a second battery, wherein a negative terminal of each of the first and second batteries are connected together at a ground point and a charging source is continuously connected in parallel with one of the first and second batteries. The battery isolator comprises an inductor having a first terminal and a second terminal. A first switch is connected between a positive terminal of the first battery and the first terminal of the inductor. A second switch is connected between a second terminal of the inductor and a positive terminal of the second battery. A third switch is connected between the first terminal of the inductor and the ground. A fourth switch is connected between the second terminal of the inductor of the ground. The first, second, third and fourth switches are selectively actuated to function as one of a buck switching converter and a boost switching converter to charge at least one of the first battery and the second battery.

Still another aspect of the present invention is a battery isolator for an electrical system that includes at least a first battery and a second battery, wherein a negative terminal of each of the first and second batteries are connected together at a ground point and a charging source is continuously connected in parallel with one of the first and second batteries. The battery isolator comprises an inductor having a first, a second, a third and a fourth winding, a first end of each winding being connected together. A first switch is connected between a positive terminal of the first battery and a second end of the first winding. A second switch is connected between a second end of the second winding and the ground. A third switch is connected between a positive terminal of the second battery and a second end of the third winding. A fourth switch is connected between a second end of the fourth winding and the ground. The first, second, third and fourth switches are selectively actuated to charge at least one of the first battery and the second battery.

### BRIEF DESCRIPTION OF THE DRAWINGS

Further features of the inventive embodiments will become apparent to those skilled in the art to which the embodiments relate from reading the specification and claims with reference to the accompanying drawing, in which:

FIG. 1 is a schematic circuit diagram of a prior art diode isolator;

FIG. 2 is a schematic circuit diagram of a prior art contactor isolator;

FIG. 3 is a battery isolator according to an embodiment of the present invention;

FIG. 4 depicts switch and diode configurations for the battery isolator;

FIG. 5 is a battery isolator according to an alternate embodiment of the present invention;

FIG. 6 is a battery isolator according to another alternate embodiment of the present invention;

FIG. 7 is a flow diagram for monitoring battery charge level to control a battery isolator according to an embodiment of the present invention; and

FIG. 8 is a battery isolator according to yet another alternate embodiment of the present invention.

### DETAILED DESCRIPTION

A diode isolator 100 common in the art is shown in FIG. 1. An electrical system, such as a vehicle electrical system, may have a first battery 102 that is used to start the vehicle's engine. A second battery 104 provides electrical power to accessories such as, for example, lighting, ventilation fans, a television and a microwave oven located in a “sleeper” cab of a truck. A charging source 106, typically an engine-driven alternator, provides a charging current to recharge batteries 102, 104.

Diodes 108, 110 are placed in series with batteries 102, 104, respectively. Diodes 108, 110 are each forward-biased for charging current supplied by charging source 106, allowing the charging current to recharge the batteries. In the event that battery 104 is depleted and charging source 106 is unavailable (i.e., the vehicle engine is not running and/or the alternator is not supplying sufficient power), the resultant lower voltage of battery 104 as compared to battery 102 reverse-biases diode 108, preventing battery 102 from discharging into battery 104 and thus preserving the charge of battery 102 for engine starting. Likewise, if battery 102 is depleted, diode 110 is reverse-biased to prevent battery 104 from being discharged by battery 102.

The diode isolator of FIG. 1 has several drawbacks. A first disadvantage is that diodes 108, 110, which are typically semiconductor diodes, have an inherent voltage drop in the range of about 0.5 to 1.0 volts. This voltage drop reduces the voltage supplied to batteries 102, 104, thus reducing the charging capability of charging source 106. Another disadvantage is that there is no way to preferentially charge one of batteries 102, 104. For example, it may be desirable to charge engine-starting battery 102 before accessory battery 104, since the starting battery is essential to starting and operating the vehicle. However, it is common to use an accessory battery 104 having a higher capacity than starting battery 102, in order to adequately supply the various accessory loads. Since it is also common to operate the accessories when the vehicle is stopped and the engine is off, the large-capacity accessory battery 104 often becomes discharged. Thus, when the vehicle's engine is started battery 104 will inherently draw a large charging current from charging source 106, which has a finite charging capacity, with a result that engine battery 102 may receive less than the desired charging current.

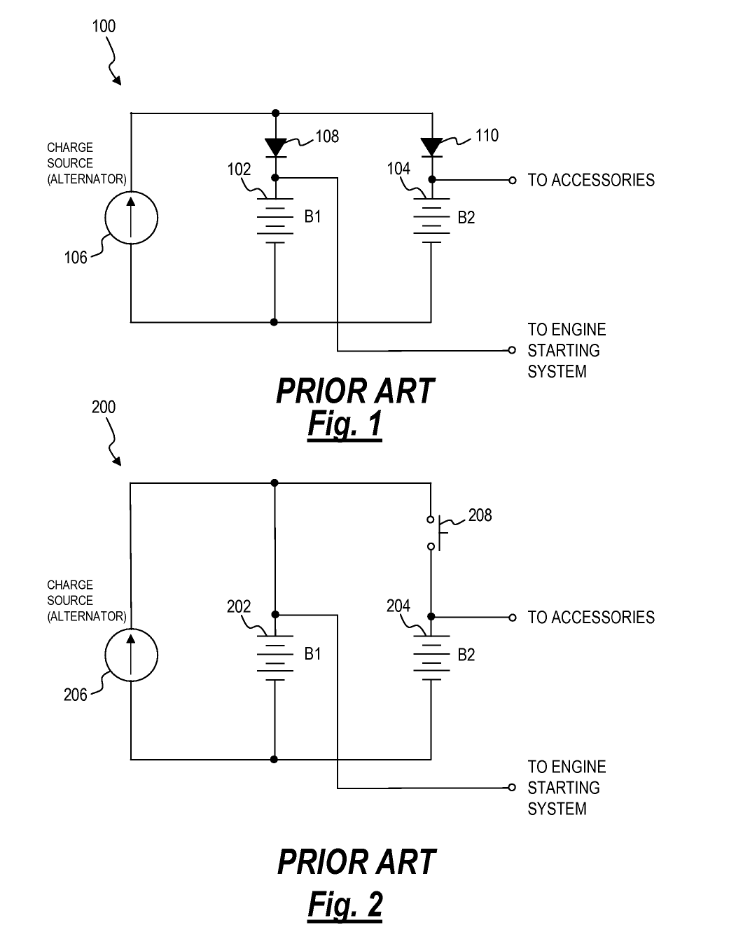

A contactor isolator 200 common in the art is depicted in FIG. 2. An electrical system, such as a vehicle electrical system, may have a first battery 202 that is used to start the vehicle's engine. A second battery 204 provides electrical power to accessories. A charging source 206, typically an engine-driven alternator, provides a charging current to recharge batteries 202, 204. In operation, contactor 208 is opened, isolating battery 204 from charging source 206. The charge state of engine starting battery 202 is monitored in any manner, such as the monitoring of battery 202 voltage and/or charging current. A battery charge control algorithm may also monitor charging based on the calculated percentage of charge of battery 202. Only after battery 202 reaches a desired charge state is contactor 208 closed, allowing charging current to flow into battery 204.

Contactor battery isolators also suffer from drawbacks. One drawback is that the large charge current associated with accessory battery 204 tends to pull down the voltage of charging source 206. Consequently, a voltage monitor associated with a charging controller (not shown) may inaccurately indicate that engine-starting battery 202 is discharged and will open contactor 208 in order to preferentially charge the engine-starting battery. Subsequently, the charging controller may determine that engine battery 202 is fully charged and close contactor 208 to charge accessory battery 204, again allowing the accessory battery to pull down the voltage of charging source 206. This cycling of contactor 208 may occur repeatedly until accessory battery 204 is at least partially recharged, resulting in accelerated wear of the contactor while also increasing the amount of time required to charge accessory battery 204.

A battery isolator 300 in accordance with an embodiment of the present invention is shown in FIG. 3. Battery isolator 300 is configured as a power converter that is capable of controlling the charging of a primary battery 302 (labeled “B1” in FIG. 3), such as an engine-starting battery, and a secondary battery 304 (labeled “B2” in FIG. 3), such as an accessory battery. Primary and secondary batteries 302, 304 may be of the same or a different voltage. Battery isolator 300 utilizes two regulation loops. A first regulation loop regulates the voltage of primary battery 302 by limiting current flow to secondary battery 304, acting to preferentially charge the primary battery so that a depleted secondary battery cannot absorb all of the charge current supplied by a charging source 306, such as an alternator.

The first control loop preferentially charges primary battery 302 by limiting the charging current supplied from charging source 306 to secondary battery 304. To accomplish this, switch 308 (labeled “S1” in FIG. 3) and/or 312 (labeled “S3” in FIG. 3) may be duty-cycle controlled (e.g., pulse width modulated) to a predetermined extent such that battery 304 receives a predetermined charge current in preference to battery 302. For example, when primary battery 302 is completely discharged, the duty cycle of switches 308, 312 will be either low or OFF entirely, causing all charging current from charging source 306 to be supplied to the primary battery. As primary battery 302 becomes charged, the duty cycle of switches 308, 312 may be increased to begin charging secondary battery 304. When battery 302 is fully charged, switches 308 and 312 may have a high duty cycle or may be ON entirely, to allow for faster charging of secondary battery 304.

Switches 308 and 312 may also be duty-cycle controlled to function as a charge current regulator for primary battery 302 and/or secondary battery 304. For example, the charging current supplied to primary battery 302 by charging source 306 may be controlled to a predetermined set value by selectively diverting a portion of the capacity of the charging source to secondary battery 304 through switches 308 and 312. Similarly, the duty cycle of switches 308 and 312 may be adjusted to apportion the charging current between batteries 302 and 304 in any desired manner, including charging the primary and secondary batteries equally, charging the primary battery preferentially to the secondary battery, and charging the secondary battery preferentially to the primary battery. Preferential charging of secondary battery 304 is possible due to its relatively large charging current relative to primary battery 302. To preferentially charge secondary battery 304, switches 308 and 312 are actuated at a duty cycle sufficient to cause a greater portion of the capacity of charging source 306 to flow into the secondary battery, the remainder of the capacity going to charge primary battery 302.

With continued reference to FIG. 3, in one example of the disclosed invention, when a voltage V₁ generated by charging source 306 is about 14.2 VDC, isolator 300 may be configured with a setpoint of about 13.8 VDC such that an appreciable charge current I₁ will mostly flow only to secondary battery 304 when the voltage of cranking battery 302 reaches about 13.8 VDC, indicating a healthy charge level. At that point, charge current from charging source 306 will be supplied to secondary battery 304 via switches 308 and 312 by increasing the duty cycle of the switches.

A second regulation loop is a current-limiting loop that prevents a fully-charged primary battery 302 from sourcing high currents to a discharged bulk storage battery 304 and so eliminates that condition as a potential failure mechanism for isolator 300. In the event that charging source 306 is not present, it is often desirable to isolate primary battery 302 from secondary battery 304 so that the energy stored in the primary battery is conserved for such actions as starting the engine of a vehicle. To accomplish this, either or both of switches 308, 312 may be set at a low duty cycle or turned OFF entirely, preventing current from flowing from primary battery 302 to secondary battery 304.

There may also exist a condition wherein charging source 306 is unavailable and primary battery 302 is discharged, but secondary battery 304 is at least partially charged. In this condition, switches 308 and 312 may be actuated to connect battery 304 to battery 302 to facilitate starting of the vehicle's engine. Alternatively, switches 308 and/or 312 may be duty-cycle controlled to provide for charging of battery 302 by battery 304. Likewise, switches 308 and 312 may be duty-cycle controlled to provide for charging of battery 304 by battery 302 when charging source 306 is not present.

With continued reference to FIG. 3, switches 308, 312 may be operated in a pulse width modulated (“PWM”) mode typical of a switched mode converter. A second pair of switches 310, 314 (labeled “S2” and “S4” respectively in FIG. 3) are complementary switches such that switch 310 actuates complementary to switch 308 and switch 314 actuates complementary to switch 312. Switches 308, 310, 312 and 314 may cooperate with an inductor 316 to function as either a “boost” converter for stepping up a charge voltage, or as a “buck” converter for stepping down a charge voltage.

As an example, the boost mode converter may function to step up a voltage V₁ from charging source 306 and/or primary battery 302 to charge a higher-voltage V₂ secondary battery 304. In this configuration, switch 308 may be closed and 310 may be open. Switches 312 and 314 cycle repetitively and in a complementary fashion at a predetermined duty cycle to store and discharge energy in inductor 316, stepping up an input voltage V₁ to a higher voltage V₂. The operation of a boost-mode switching converter is well-known in the art, and thus details of the components and controls typically associated with such converters is left to the artisan.

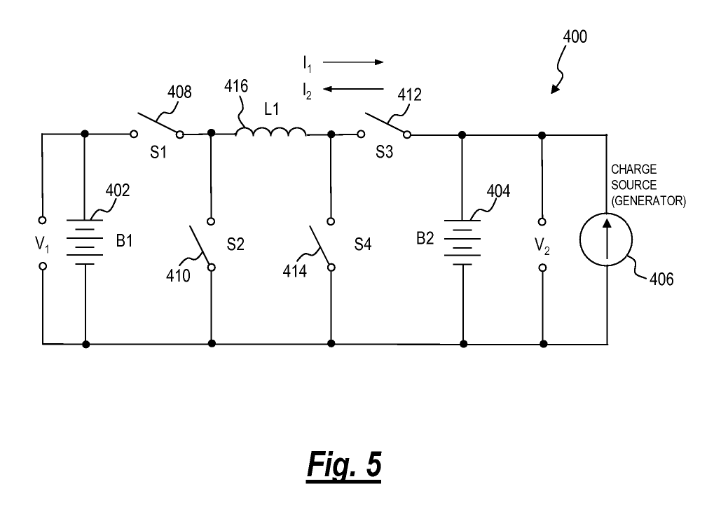

Similarly, the boost converter may be utilized to step up a voltage V₂ to a higher-level V₁. In this configuration, switch 312 may be closed and switch 314 may be open. Switches 308 and 310 cycle repetitively and in a complementary fashion at a predetermined duty cycle to store and discharge energy in inductor 316, stepping up input voltage V₂ to a higher voltage V₁. In this configuration charging source 306 is preferably connected to battery 304 in the same manner that charging source 406 of FIG. 5 is connected to battery 404.

With continued reference to FIG. 3, switches 308, 310, 312, 314 may also function in a switching converter buck mode to step down an input voltage to a lower voltage. In a first buck configuration voltage V₁ is stepped down to a lower voltage V₂ by keeping switch 312 ON and switch 314 OFF. Switches 308 and 310 cycle repetitively and in a complementary fashion at a predetermined duty cycle to store and discharge energy in inductor 316, stepping down input voltage V₁ to a level compatible with battery 304.

Likewise, a higher voltage V₂ may be stepped down to a lower voltage V₁ by keeping switch 308 closed, switch 310 open, and cycling switches 312 and 314 repetitively and in a complementary fashion at a predetermined duty cycle. In this configuration charging source 306 is preferably connected to battery 304 in the same manner that charging source 406 of FIG. 5 is connected to battery 404. The operation of a buck-mode switching converter is well-known in the art, and thus details of the components and controls typically associated with such converters is left to the artisan.

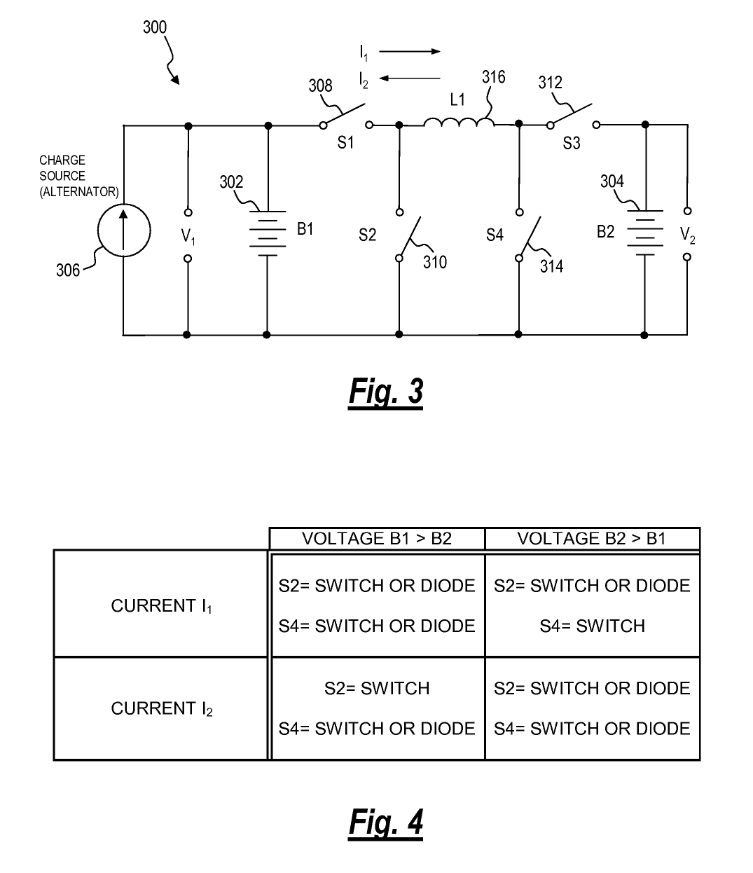

With reference now to FIGS. 3 and 4 in combination, in an alternate embodiment switches 310 and 314 may be diodes for some switching converter configurations of battery isolator 300. For example, if primary battery 302 is at a higher voltage than secondary battery 304, a charging current I₁ will flow and a buck converter configuration may be used. Switch 310 may be a diode, acting with switch 308 and inductor 316. Similarly, if secondary battery 304 is a higher voltage than battery 302 and a current I₂ is desired, switch 314 may be a diode and function with switch 312 and inductor 316 as a buck converter. FIG. 4 details configurations wherein a diode may be substituted for at least one of switch 310 and 314 for various configurations of battery isolator 300.

Switches 308-314 of FIG. 3 may be any type of conventional electronic switch including, without limitation, bipolar transistors, field effect transistors, and solid state relays. The means for controlling the switching operation of switches 308-314 and duty cycle control of the switches is well known and will not be repeated here.

Referring now to FIG. 5, a battery isolator 400 according to an embodiment of the present invention may be configured for operation when a charging source 406 is connected to a secondary battery 404. This configuration is applicable for conditions wherein the vehicle is connected to an external charging source 406, such as a generator or a battery charger. In this configuration a secondary battery 404 may be charged preferentially by opening switches 408 and 412 (labeled “S1” and “S3,” respectively) to limit charging of primary battery 302. If both primary battery and secondary battery are to be charged concurrently, switches 408 and 412 may be closed. Switches 408, 410 (labeled “S1” and “S2”, respectively), 412 and 414 (labeled “S3” and “S4”) may cooperate with an inductor 416 to function as a buck or boost switching converter in the same manner as described above for switches 308, 310, 312, 314 and inductor 316 (see FIG. 3) and will not be repeated here. Likewise, switches 410 and 414 may be replaced by diodes in the same manner as switches 310 and 314, discussed above and summarized in FIG. 4.

Although not shown for reasons of clarity, it is anticipated that battery isolators 300, 400 will include a charging control portion for monitoring voltages, currents, battery charge/discharge state, changing operating modes of the battery isolator, and controlling the operation of switches 308-314 and 408-414. The control portion may include conventional analog and/or digital control circuitry, and may further include a microprocessor, microcontroller, or other similar device that is capable of executing a predetermined set of instructions and/or algorithms, such as computer software.

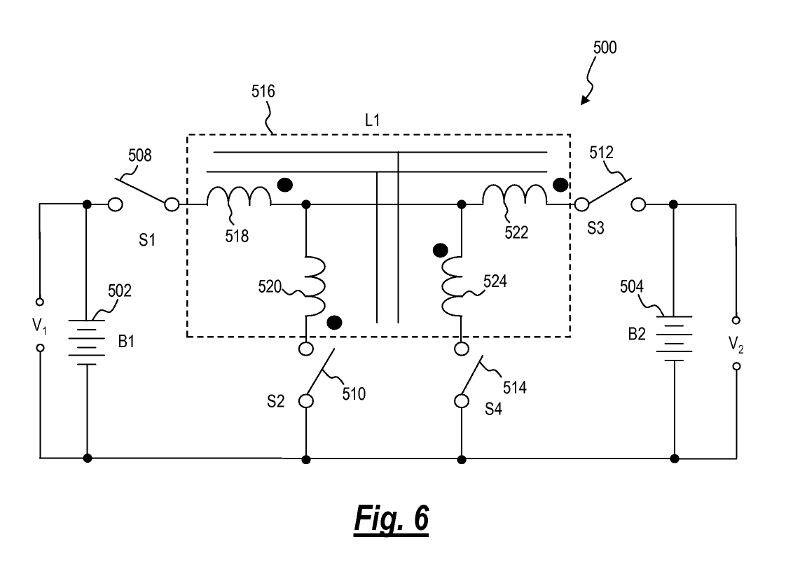

Another alternate embodiment of the present invention is shown in FIG. 6. In this embodiment a converter 500 is a “push-pull” configuration rather than a buck-boost configuration. An inductor 516 includes four windings 518, 520, 522 and 524. In a first operational mode windings 518, 520 may be pulse-width modulated by a first electronic switch 508 and a second electronic switch 510 to step up or step down a voltage V₁, such as a battery 502 voltage, to a higher or lower voltage V₂, such as a battery 504. In this mode a third electronic switch 512 is closed and a fourth electronic switch 514 is open. The amount of voltage step-up or step-down is controlled by both the turns ratio of windings 518, 520 and the duty cycle of pulse width modulation of switches 508, 510.

Likewise, in a second operational mode windings 522, 524 may be pulse-width modulated by switch 512 and switch 514 to step up or step down a voltage V₂ to a higher or lower voltage V₁. In this mode switch 508 is closed and switch 510 is open. The amount of voltage step-up or step-down is controlled by both the turns ratio of windings 522, 524 and the duty cycle of pulse width modulation of switches 512, 514.

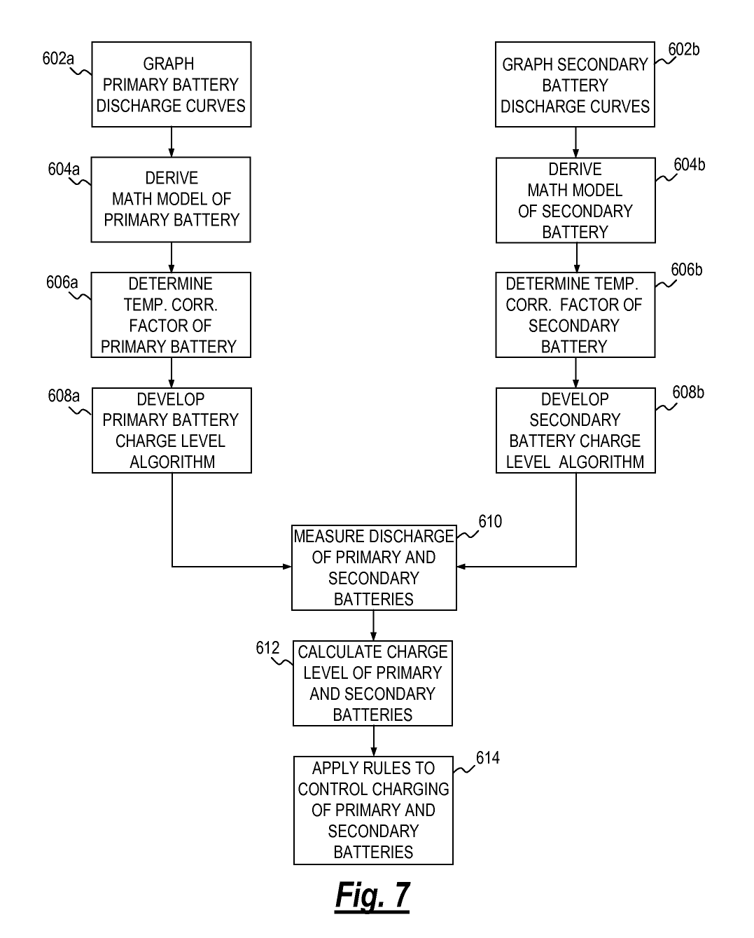

With reference to FIG. 7, in some embodiments the battery isolators of FIGS. 3, 5 and 6 may include monitoring of battery charge levels to control preferential charging, rather than monitoring battery voltage and/or charging current. For example, graphical curves representing the actual discharge of each battery at any moment in time can be generated, as in steps 602a and 602b for a primary battery and a secondary battery respectively. By extrapolation to the end of the discharge of each battery, such information as: 1) time remaining under the present load; and 2) percentage of battery capacity remaining can be calculated, as well as comprehensive battery performance data. Mathematical models for the primary and secondary batteries may be established, as at steps 604a and 604b respectively, based on sets of three-dimensional discharge curves using time, voltage and current as constraints. Each model describes an infinite number of curves covering various discharge rates. Temperature correction factors relating to the primary and secondary batteries are determined at steps 606a and 606b respectively, creating a fourth constraint. By monitoring each battery cell of the primary and secondary batteries during a discharge test it is possible to generate a charge level algorithm for the primary and secondary batteries, as at steps 608a and 608b respectively, to calculate at any point in time the mean position of the battery as a whole, based on its characteristic three-dimensional surface plot. The battery isolator may monitor discharge of the primary and secondary batteries, as at step 610, and continuously or periodically calculate the charge level of each battery at step 612. The battery isolator may then control charging of the batteries based on predetermined criteria, as at step 614. For example a control portion of the battery isolator may include battery monitoring capability as part of its control algorithm and may allow current flow to the secondary battery only after the primary battery exceeds a certain charge level (such as about 80% for example). Such a control algorithm may also take into account other system conditions to alter a preferential charging scheme, such as permitting charging of the secondary battery if the charging source is capable of delivering more charging current than required to charge the primary battery. Example system conditions include, but are not limited to, battery condition monitoring such as is discussed in U.S. Pat. No. 5,394,089, the entire text of which is hereby incorporated by reference.

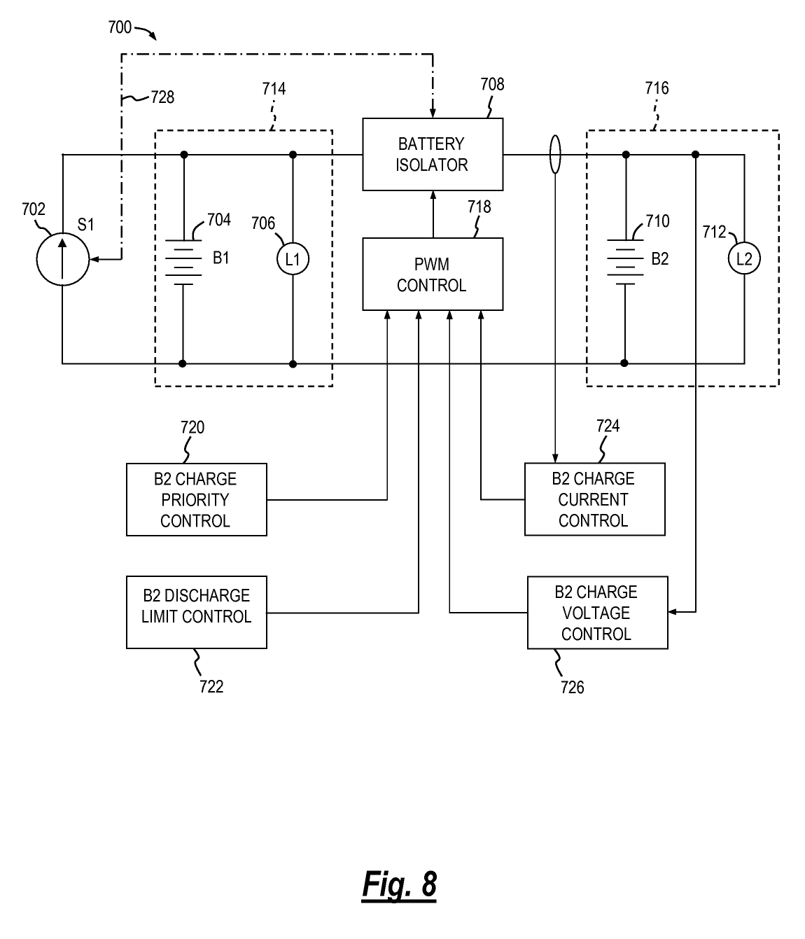

A vehicle electrical system 700 is shown in FIG. 8 according to yet another embodiment of the present invention. Electrical system 700 comprises a charging source 702, a first battery 704, a first load 706, a battery isolator 708, a second battery 710 and a second load 712.

First battery 704 is typically a cranking battery for starting an internal combustion engine (not shown), the starter of the engine being generally represented by first load 706. First load 706 also represents loads imposed upon electrical system 700 by essential vehicle controls such as, for example, an engine controller and driving lights. Collectively, first battery 704 and first load 706 are termed primary subsystem 714 herein.

Second battery 710 is provided for energy storage. Second battery 710 also provides power to second load 712, which generally represents loads placed on system 700 by auxiliary (i.e., lower priority) loads such as, for example, cabin lighting and accessories. Collectively, second battery 710 and second load 712 are termed secondary subsystem 716 herein.

Battery isolator 708 controls electrical energy provided to secondary subsystem 716 by either or both charging source 702 and first battery 704. In one embodiment of the present invention battery isolator 708 includes (or is controlled by) a pulse width modulation (PWM) control 718 which utilizes signal inputs from one or more of a charge priority control 720, a discharge limit control 722, a charge current control 724 and a charge voltage control 726. PWM control 718 pulse width modulates the duty cycle of battery isolator 708 in a predetermined manner to control the voltage and/or current supplied to secondary subsystem 716 via the battery isolator by either or both charging source 702 and first battery 704, as detailed more fully below.

If first battery 704 requires recharging in preference to supplying energy to secondary subsystem 716 charge priority control 720 acts to limit (or cut off entirely) energy transferred to secondary subsystem 716 by reducing the duty cycle of battery isolator 708 to an appropriately low value, thereby isolating second electrical subsystem 716 from charging source 702 and first battery 704. During such operating conditions energy from charging source 702 is supplied to first battery 704, as well as first load 706. If excess energy from charging source 702 is available in addition to supplying energy to first battery 704 and first load 706, charge priority control 720 may be configured to increase the duty cycle of battery isolator 708 to provide energy to secondary subsystem 716 via the battery isolator in proportion to the amount of excess energy available beyond that needed to support primary subsystem 714.

Depending upon the operational requirements of electrical system 700, energy supplied to secondary subsystem 716 via battery isolator 708 can be further PWM controlled by PWM control 718 to give priority to either second battery 710 or second load 712. For example, PWM control 718 may be configured to set the PWM duty cycle of battery isolator 708 to a relatively low duty cycle PWM, in which case a discharged second battery 710 (which appears as a relatively low-impedance load to the battery isolator) will receive a significant portion of the energy of charging source 702 and/or first battery 704 provided to secondary subsystem 716 via the battery isolator. Under some vehicle operating conditions second load 712 may be deemed essential to the operation of the vehicle. In such cases PWM control 718 may direct battery isolator 708 to operate at a sufficiently high PWM duty cycle such that, regardless of the charging state of first battery 706, adequate power is supplied to second load 712. The PWM duty cycle of battery isolator 708 may further be set to a relatively high duty cycle by PWM control 718 so that second load 712 will receive a significant portion of the energy provided to secondary subsystem 716 by the battery isolator in the manner previously described.

Because of the functional differences between first battery 704 and second battery 710 in supplying the first and second electrical subsystems 714, 716, respectively, the two batteries may have different electrical attributes, such as voltage and amp-hour capacity. First and second batteries 704, 710 may also be of differing type and thus may require different recharge characteristics. Accordingly, charge current control 724 and/or charge voltage control 726 may direct PWM control 716 to establish a duty cycle of battery isolator 708 to an average charge voltage and/or current that is compatible with second battery 710. Likewise, second battery 710 may be used to charge first battery 704 by appropriately configuring battery isolator 708 and establishing a predetermined duty cycle of the battery isolator with PWM control 718 to produce a charge voltage and/or current that is compatible with the first battery.

In operation, electrical system 700 may be configured in a number of different ways, depending upon the operational status of the electrical system and the priorities of various loads coupled to the system. In a first configuration, electrical system 700 may include monitoring of charging source 702 to estimate the condition of the system and establish the amount of load to apply thereto. For example, in a typical 12 volt electrical system 700 first battery 704 will be charging with any voltage above about 13.6 volts and the set point of charging source 702 will be about 14.2 volts. Battery isolator 708 can be configured to regulate the input voltage from charging source 702 to about 13.9 volts by appropriately loading the charging source, by increasing the duty cycle of the battery isolator and shunting a portion of the energy to an electrical ground of system 700 if the voltage increases above this threshold. Battery isolator 708 may likewise be adjusted by PWM control 718 to increase its PWM duty cycle (and thus its output to subsystem 716) as the input voltage (i.e., the voltage of charging source 702) rises from about 13.7 volts to about 14 volts. Thus, battery isolator 708 will only divert charge current when there is sufficient energy to charge first battery 704. Accordingly, the load imposed upon charging source 702 will be limited.

In another configuration of electrical system 700 a feedback control loop 728 may be established between charging source 702 and battery isolator 708, as generally shown in FIG. 8. Control loop 728 may be configured using any conventional format including, without limitation, analog signals, digital signals and data buses such as a controller area network (CAN bus). Accordingly, battery isolator 708 may directly monitor the load voltage and/or current status of charging source 702 and responsively control the amount of energy supplied to subsystem 716 via the battery isolator. This will limit the load imposed upon the charging system to a predetermined maximum of its capacity, such as about 98 percent of the capacity of charging source 702, for example. Thus, in one embodiment feedback control loop 728 is coupled between charging source 702 and battery isolator 708 and system 700 functions such that the battery isolator responsively controls the amount of energy supplied to secondary subsystem 716 in accordance with the available capacity of the charging source, limiting the flow of energy to the secondary subsystem as needed to prevent exceeding the capacity of the charging source.

In yet another configuration of electrical system 700 battery isolator 708 may be configured to monitor the current supplied to subsystem 716 by second battery 710. If second load 712 is active and charging source 702 is heavily loaded, a discharge limit control 722 may act to reduce the duty cycle of battery isolator 708 to a minimal value via PWM control 718. Hence, second load 712 will not consume current from second battery 710, but neither will the second battery consume charge current from charging source 702. This configuration may also be used to prevent second subsystem 716 from discharging first battery 704 via battery isolator 708 under some certain conditions, such as when charging source 702 is not providing charging voltage and/or current. Discharge limit control 722 may also act to command PWM control 718 to reduce the duty cycle of battery isolator 708 to a low level for certain conditions wherein it is desirable to prevent first subsystem 714 from discharging energy stored in second battery 710 via the battery isolator.

Conversely, when charging source 702 has excess energy capacity over and above that required by first subsystem 714, the PWM duty cycle of battery isolator 708 may be set to the lesser of the charging capacity of second battery 710 and the maximum capacity of the charging source.

Battery isolator 708 may be configured in several ways, depending upon the needs of electrical system 700. For example, if the predetermined (i.e., nameplate) voltages of first and second batteries 704, 710 respectively are such that the voltage of the second battery is always less than that of the first battery and electrical isolation is not required, battery isolator 708 may be less complex and thus built at a lower cost than either an isolated system, or a system wherein voltage step-up conversion or step-down conversion between the first and second batteries is required. In other configurations battery isolator 708 may be bi-directional to provide for the transfer of energy from second battery 710 to first battery 704. For example, if the cranking battery (e.g., first battery 704) is discharged, battery isolator 708 can be configured to provide an energy path from second battery 710 to first battery 704, thereby using energy stored in the second battery to re-charge the first battery.

PWM control 718, charge priority control 720, discharge limit control 722, charge current control 724 and charge voltage control 726 all represent control elements that affect the operation of battery isolator 708 and, in turn, electrical system 700 in a predetermined manner. It is understood that these control elements may be realized as separate subsystems. Conversely, some or all of the control elements may be integrated together. Furthermore, the control elements may be realized utilizing analog control circuitry or may include, in part or as a whole, a digital control system operating in accordance with characteristics defined by a set of instructions stored in a computer-readable medium, such as a computer program.

While this invention has been shown and described with respect to a detailed embodiment thereof, it will be understood by those skilled in the art that changes in form and detail thereof may be made without departing from the scope of the claims of the invention. For example, conventional filters may be connected to the input and/or output of the isolator to smooth the input and/or output voltage and current, and to meet desired electromagnetic compatibility requirements. In addition, conventional resonant switching circuits may be incorporated into the isolators disclosed herein, improving performance and efficiency. Such resonant circuits are well-known in the art and will not be discussed herein.

What is claimed is:

1. In an electrical system that includes at least a first battery and a second battery, wherein a negative terminal of each of the first and second batteries are connected together at a ground point and a charging source is continuously connected in parallel with one of the first and second batteries, a battery isolator comprising:
an inductor having a first terminal and a second terminal;
a first switch connected between a positive terminal of the first battery and the first terminal of the inductor; and
a second switch connected between a second terminal of the inductor and a positive terminal of the second battery,
wherein the first and second switches are selectively actuated to charge at least one of the first battery and the second battery.

2. The battery isolator of claim 1 wherein a charging source is continuously connected to the first battery and charging of the second battery is controlled by at least one of the first and second switches.

3. The battery isolator of claim 1 wherein a charging source is continuously connected to the second battery and charging of the first battery is controlled by at least one of the first and second switches.

4. The battery isolator of claim 1 wherein at least one of the first and second switches is duty-cycle controlled to limit the flow of charging current.

5. The battery isolator of claim 1 wherein at least one of the first and second switches are selectively actuated to prevent one of the first and second batteries from substantially discharging the other battery.

6. The battery isolator of claim 1 wherein the charging current supplied to one of the first and second batteries is regulated by selectively diverting a portion of the capacity of a charging source to the other battery through the first and second switches.

7. The battery isolator of claim 1 wherein the first and second switches are selectively actuated to allow the second battery to charge the first battery.

8. The battery isolator of claim 1 wherein the first and second switches are selectively actuated to allow the first battery to charge the second battery.

9. The battery isolator of claim 1, further comprising a control portion to monitor the charge state of the first and second batteries and control the actuation of the first and second switches.

10. In an electrical system that includes at least a first battery and a second battery, wherein a negative terminal of each of the first and second batteries are connected together at a ground point and a charging source is continuously connected in parallel with one of the first and second batteries, a battery isolator comprising:
an inductor having a first terminal and a second terminal;
a first switch connected between a positive terminal of the first battery and the first terminal of the inductor;
a second switch connected between a second terminal of the inductor and a positive terminal of the second battery;
a third switch connected between the first terminal of the inductor and the ground; and
a fourth switch connected between the second terminal of the inductor of the ground;
wherein the first, second, third and fourth switches are selectively actuated to charge at least one of the first battery and the second battery.

11. The battery isolator of claim 10 wherein the first and third switches cooperate with the inductor to function as a boost switching converter to supply the second battery with a voltage greater than that of the first battery.

12. The battery isolator of claim 11 wherein the charging source is continuously connected to the first battery.

13. The battery isolator of claim 10 wherein the second and fourth switches cooperate with the inductor to function as a boost switching converter to supply the first battery with a voltage greater than that of the second battery.

14. The battery isolator of claim 13 wherein the charging source is continuously connected to the second battery.

15. The battery isolator of claim 10 wherein the second and fourth switches cooperate with the inductor to function as a buck switching converter to supply the second battery with a voltage less than that of the first battery.

16. The battery isolator of claim 15 wherein the charging source is continuously connected to the first battery.

17. The battery isolator of claim 10 wherein the first and third switches cooperate with the inductor to function as a buck switching converter to supply the first battery with a voltage less than that of the second battery.

18. The battery isolator of claim 17 wherein the charging source is continuously connected to the second battery.

19. The battery isolator of claim 10 wherein at least one of the third and fourth switches is a diode.

20. The battery isolator of claim 10, further comprising a control portion to monitor the charge state of the first and second batteries and control the actuation of the first, second, third and fourth switches.

21. In an electrical system that includes at least a first battery and a second battery, wherein a negative terminal of each of the first and second batteries are connected together at a ground point and a charging source is continuously connected in parallel with one of the first and second batteries, a battery isolator comprising:
an inductor having a first terminal and a second terminal;
a first switch connected between a positive terminal of the first battery and the first terminal of the inductor;
a second switch connected between a second terminal of the inductor and a positive terminal of the second battery;
a third switch connected between the first terminal of the inductor and the ground; and
a fourth switch connected between the second terminal of the inductor of the ground,
wherein the first, second, third and fourth switches are selectively actuated to function as one of a buck switching converter and a boost switching converter to charge at least one of the first battery and the second battery.

22. In an electrical system that includes at least a first battery and a second battery, wherein a negative terminal of each of the first and second batteries are connected together at a ground point and a charging source is continuously connected in parallel with one of the first and second batteries, a battery isolator comprising:
an inductor having a first, a second, a third and a fourth winding, a first end of each winding being connected together;
a first switch connected between a positive terminal of the first battery and a second end of the first winding;
a second switch connected between a second end of the second winding and the ground;
a third switch connected between a positive terminal of the second battery and a second end of the third winding; and
a fourth switch connected between a second end of the fourth winding and the ground;
wherein the first, second, third and fourth switches are selectively actuated to charge at least one of the first battery and the second battery.

23. A vehicle electrical system, comprising:
a first battery having a first load coupled thereto, forming a first electrical subsystem;
a second battery having a second load coupled thereto, forming a second electrical subsystem;
a charging source continuously coupled to one of the first and second electrical subsystems; and
a battery isolator coupled between the first and second electrical subsystems,
wherein the battery isolator is selectably configurable to control the flow of energy between the first and second electrical subsystems.

24. The electrical system of claim 23, further comprising a charge priority control configured to control the operation of the battery isolator to preferentially supply energy from the charging source to at least one of the first battery, second battery, first load and second load.

25. The electrical system of claim 23, further comprising a discharge limit control to limit the discharge of at least one of the first and second batteries.

26. The electrical system of claim 23, further comprising a feedback control loop coupled between the charging source and the battery isolator, whereby the battery isolator responsively controls the amount of energy supplied to the second electrical subsystem in accordance with the available capacity of the charging source.
